(19) United States
(12) Patent Application Publication
(10) Pub. No.: US 2008/0276309 A1
(43) Pub. Date: Nov. 6, 2008

(54) System and Method for Securing Software Applications

(76) Inventor: Lance F. Edelman, Atlanta, GA (US)

Correspondence Address: RUSSELL L. SANDIDGE;JOYCE, THRASHER & KAISER, LLC, 150 SOUTH TERRACE, 115 PERIMETER CENTER PLACE, NE, ATLANTA, GA, 30346-1284, US

(21) Appl. No.: 11/456,039

(22) Filed: Jul. 6, 2006

(51) Int. Cl. H04L 9/32; H04L 9/30

(52) U.S. Cl. 726/9; 380/255; 380/259

(57) ABSTRACT

A system and method for securing software applications installed on a computer network is disclosed. An authorized user is provided a digital credential and loads a secure access client onto a computerized device that can be connected to the network. The secure access client communicates with a secure access server within the network to authenticate the user and determine which applications the user is allowed to access. When the user sends a communication intended for a secured application, the secure access client intercepts the communication and uses cryptographic keys from the digital credential to encrypt and digitally sign the communication. The secure access server has access to cryptographic keys corresponding to those on the digital credential and is able to decrypt the communication and verify the digital credential. The decrypted message is then sent to an application server hosting the secured application.

### BACKGROUND OF THE INVENTION

1. Field of the Invention

The present invention relates generally to a system and method for securing software applications, and more specifically to a system and method for authenticating users of a computer network and securing communication between the authenticated users and software applications located on such computer network.

2. Technical Background

Software Applications are the basic foundation of many businesses. As application technology continues to advance, businesses are automating more of their business functions in an effort to improve productivity. The automation of previously manual tasks touches nearly every employee, requiring them to perform their job duties through computer-based software applications. These applications are often located on servers within a computer network, and are accessed by utilizing various types of computing devices connected to the network. The result is that businesses have a variety of people authorized to access a variety of applications via a computer network, and these businesses need an effective method to control who accesses, creates, maintains, modifies and deletes data related to the use of these applications. Managing user authentication and access to multiple applications and their associated data within a computer network is a complex task that is not handled consistently from business to business. Meanwhile, a growing body of legislation is making security failures a publicly visible event with the potential for costly financial penalties.

The traditional and widely used approach to network security is a line of defense; a perimeter of security designed around the organization's network to protect applications from malicious intrusion from the outside. Traditional security tools such as firewalls, virtual private networks, and intrusion detection and prevention systems have been developed for the purpose of identifying and stopping malicious intrusions before they reach the internal network applications. These traditional methods, however, are reactive and defensive in nature and have several critical shortcomings. Attempting to stop everything from everywhere is ineffective, as numerous recent breaches of business networks have shown. A single breach of the perimeter exposes all applications within the network to the threat. In addition, there has been no significant effort to date directed towards securing critical applications from attacks from otherwise legitimate users within the network. Most existing security tools are focused on external threats, and do not address threats originating from within the network.

Businesses also may have different levels of security concerns for different applications on the network depending upon the sensitivity of the data housed by the application. For example, some applications housing data which is deemed to be low sensitivity may allow access to any authorized user of the computer network without additional authentication or communication encryption. Other applications housing very sensitive data may demand strong authentication of users and require communication encryption in order to secure the data from unauthorized interception. Few tools are currently available that effectively provide varying degrees of security to different applications within a network based upon the sensitivity of the data associated with those applications.

In networked computer systems, users of computer applications are typically required to authenticate themselves to the application or the server that houses the application. When the information involved is of relatively low value, simple user ID and password authentication may be sufficient. An authorized user enters his ID and password, and a server on the network compares that information to a stored list and establishes a communication session if the entered pair matches a stored pair.

However, when the information involved is of high value, or when the data is being transmitted over an unsecured network, simple passwords may be insufficient to effectively authenticate authorized users. The security of a user ID and password system is based upon the premise that only the user knows his/her password. As the number of passwords a user must possess increases, users typically resort to selecting simple passwords that are easy to remember, or using the same password for multiple applications they must access, which results in the use of passwords that are easily deduced by potential intruders. Some users even write their passwords down rather than rely on their own memory, and a written password may be easily misappropriated. Passwords may also be copied using malicious programs known as “key loggers” that are capable of capturing typed passwords and transmitting them to a hacker, all without the knowledge of the unsuspecting user.

In the absence of an effective solution to the security exposure of user ID and passwords, many businesses have attempted to mandate stronger password standards requiring more complex passwords that are not easily guessed. This however has not addressed the issue of misappropriation of passwords, and it has only facilitated the dangerous problem of users writing their passwords down. In the end, businesses are faced with the inability to properly enforce password standards and ultimately application security. The inherently weak security nature of user ID and passwords coupled with the inability of businesses to effectively control password standards has placed many businesses in a precarious position related to security of their applications. A secure and effective method to authenticate users of applications beyond simple user ID and passwords is required.

Alternative technologies have been developed in an attempt to overcome the insecurity of user ID and password protection. One such technology is Single Sign-On (SSO). SSO is a software based authentication that enables a user to login once and gain access to multiple applications. The SSO application stores a user's various IDs and passwords and, upon successful authentication, the SSO application will automatically provide the relevant ID and password to the associated application. SSO has not been widely adopted by businesses due to its implementation complexity and security exposure. If the user's access to the SSO application is comprised, or the SSO application itself is directly comprised, all of the application specific user ID and passwords being managed by the SSO are also compromised.

Another technology developed to overcome the insecurity of user ID and password protection is symmetric key cryptography, used to encrypt communications passed between the user and the computer network. In symmetric key cryptography, two parties who wish to communicate in private share a common key or “shared secret.” The sender encrypts the communication with the shared secret to generate an encrypted message, and the receiver decrypts the communication using the same shared secret. In a computer network environment, the shared secret is preferably known only to an authentic user and is stored somewhere accessible to the network server in communication with the user. An attacker who does not know a valid shared secret cannot send an unauthorized communication to a network server, and similarly cannot decrypt an intercepted communication.

Symmetric keys may also be used to provide integrity and authentication of messages in a network. Integrity and authentication means that the receiver knows who sent a message and that the message has not been modified during transmission. Integrity and authentication is achieved by attaching a Message Authentication Code (MAC) to a message. The sender uses an algorithm to compute the MAC, encrypts the MAC using a shared secret, and attaches the encrypted MAC to the communication. When the communication reaches its destination, the receiver can decrypt the MAC and run the reverse algorithm to verify that the communication is authentic and intact. MACs are typically constructed using message digest functions, or “hash” functions. The current Internet standard for this purpose is known as hash-based MAC (HMAC).

Symmetric keys have been in use for many years and have always suffered from a major problem, namely, effective distribution of the various keys needed to successfully perform the cryptology. In addition, a knowledgeable intruder may defeat symmetric key cryptography if he can obtain a valid shared secret either by theft form a user, or by hacking into the computer network system where the shared secrets are stored.

Another technology used to overcome the shortcomings of both the user ID and password system and symmetric key cryptography is Public Key Infrastructure or PKI. PKI utilizes a more advanced cryptographic key method known as asymmetric key cryptography. Asymmetric cryptography involves the generation of two mathematically related keys generally referenced as a private key and a public key. The mathematical relationship between the keys provides for a situation in which a message encrypted with one of the two keys may then be decrypted with the other. The public key is designed to be publicly available to anyone who is intended to receive confidential communications, while the private key is designed to be held in the physical possession of its rightful owner and serve as the owner's authentication credential. The encryption algorithms associated with asymmetric cryptography are typically so strong that no attempt to crack the algorithm would be feasible. A potential intruder would be required to steal a receiver's private key in order to decrypt an intercepted communication.

PKI utilizes an arrangement where a trusted third party, otherwise known as a Certificate Authority, vouches for the authenticity of a user by verifying that user's digital public key certificate. The sender obtains the receiver's public key from a Certificate Authority in order to send a secure communication to the receiver with no other communication required. The owner of the associated private key could decrypt a communication that was previously encrypted with their public key, and in theory only the intended receiver has access to that private key. The sender of a communication could also possess a digital certificate and digitally sign the communication with their private key. In such a case, the receiver of the communication could then obtain the senders public key from a Certificate Authority in order to verify the authenticity of the digital signature of the sender associated with the communication.

However, there are still several design and implementation issues present with security products that have attempted to use PKI. First, PKI is not suitable for encrypting large amounts of data, as the processing requirements are too burdensome for most computer systems. Second, there are serious integration issues to be addressed if communications with applications stored on a network are to be encrypted utilizing PKI or another form of asymmetric cryptography. In addition, since the private and public keys are typically stored on a user's computing device, if that device is misappropriated then an unauthorized user might still gain access to the network unless there is some additional means to verify the identity of the user. There are also some security exposures related to the way in which keys are distributed and certificates are revoked. As a result, PKI has not been widely adopted by businesses as a standard means to secure widely used software applications.

Thus there is a need for a software application security system that implements the strong security of asymmetric cryptography in a manner which alleviates the current complexity, implementation, and inoperability issues that plague current product offerings.

### SUMMARY OF THE INVENTION

One object of the present invention is providing a computer network system for securing user communication with a software application. The system comprises an access client installed on the user's computing device, and a digital credential that stores the user's encryption keys. The access client is in digital communication with a secure access server of the network system, and uses the encryption keys stored on the digital credential to encrypt and decrypt communication with the secure access server. The secure access server has access to the public and private keys necessary to decrypt and encrypt communication with the access client, and is also in digital communication with an application server comprising the application that is being secured by the present invention. The secure access server decrypts communication from the access client, and forwards the decrypted communication to the application server, and similarly encrypts communication from the application server and forwards the encrypted communication to the access client.

In another embodiment of the invention, the application server further comprises its own access client and digital credential, which allows communication between the application server and secure server to also be encrypted, although the encryption preferably uses different cryptographic keys than the communication between the user's access client and the secure server. In this way, access to the application is fully secured within the network.

In still another embodiment, the digital credential is stored on a portable digital medium and symmetrically encrypted with a pass phrase known only to the user. The user provides the pass phrase to the access client so that it can decrypt the cryptographic keys. The encryption process then involves randomly generating a shared secret and symmetrically encrypting the communication with that shared secret. The shared secret is then asymmetrically encrypted using the cryptographic keys of the digital credential. The secure access server then utilizes the stored cryptographic keys to decrypt the shared secret, and then uses the shared secret to decrypt the communication.

Another aspect of the present invention provides a method for securing user communication with a software application. The method comprises providing a digital credential comprised of user cryptographic keys to an access client installed on a computing device in digital communication with a computer network housing the secured application. The access client uses the cryptographic keys stored on the digital credential to encrypt communication input by the user and intended for the secured application. The encrypted message is sent to a secure access server within the network. The secure access server has access to corresponding cryptographic keys to decrypt the communication, and sends the decrypted communication to an application server where the application is run. Communication from the application intended for the user is returned to the server, encrypted, and then sent to the secure client for decryption.

In still another embodiment, the method of the present invention further provides for the secure access server re-encrypting the user communication prior to sending it to the application server. The application server has an application access client with access to corresponding cryptographic keys so that the application client may decrypt the re-encrypted user communication, and then provide the decrypted communication to the application to run. When the application provides a responsive communication for the user, the application access client encrypts the application communication and sends it to the secure access server. The secure access server utilizes cryptographic keys to decrypt and verify the application communication, and then re-encrypts the application communication and sends it to the access client.

Another embodiment of the present invention provides a method for securing and authenticating a user of an application located on a computer network. The user first verifies himself to an unsecured server, and is provided a digital credential comprising cryptographic keys. The digital credential is password protected by the user. The user then provides the digital credential and password to an access client installed on a computing device, and the access client uses the password to access the cryptographic keys of the digital credential. The cryptographic keys are used to encrypt and digitally secure communications intended for the network.

### BRIEF DESCRIPTION OF THE DRAWINGS

FIG. 1 schematically illustrates a computer network system embodying aspects of the present invention. A user with a digital credential and access client is shown connecting to the secure access server via a computer network. Also shown are a secured application server, a security administrator, and other preferred aspects of the network system.

FIG. 2 provides a flow diagram illustrating how the secure server separates authenticated and secure communications from unsecured communications.

FIG. 3 schematically illustrates the transfer of digitally signed and encrypted data between the user's access client, the secure access server, and the application server.

FIG. 4 is a flow chart illustrating possible steps a user could take for creating the digital credential.

FIG. 5 is a flow chart illustrating the possible steps an access client could take to compare, match, intercept, digitally sign and encrypt communications originating from a user and their computing device, and transmit those communications through one embodiment of the present invention, to the intended application.

### DETAILED DESCRIPTION

The present invention employs client/server network architecture in order to restrict communication with software applications to authorized users. Those skilled in the art will recognize that computer networks may be set up in many different ways, and that the terms “server” and “client” may encompass a variety of hardware configurations. Generally, a “server” is a computer system that provides services to other computer systems, the “clients”, over a computer network. Though used in the singular format herein, in practice the functions of a “server” or “client” might be spread among multiple pieces of computer hardware, so long as such multiple pieces of hardware are able to act together. The primary server component of the present invention, referenced herein as Secure Access Server 100, is preferably installed behind a firewall within a computer network. The primary client component of the present invention, referenced herein as Access Client 210, is software installed on the computing devices of all users 200 who require access to applications secured with the present invention. Access Client 210 preferably monitors all outward bound communications originating from the user's computing device and intercepts and secures only those communications intended for specific, pre-designated applications located within the network. Such communications may be identified by the associated IP and port address for the communication and may be matched against a previously generated Secure Application List 215, which is stored somewhere accessible to Access Client 210. Communications that match Secure Application List 215 are secured and transmitted to Secure Access Server 100 where their authenticity may be tested and the current security policy may be checked. All communications intended for applications secured with the present invention must first pass through Secure Access Server 100 for authenticity and policy checks, and thereby the security checks of the present invention are conducted prior to any communication reaching secured applications 300.

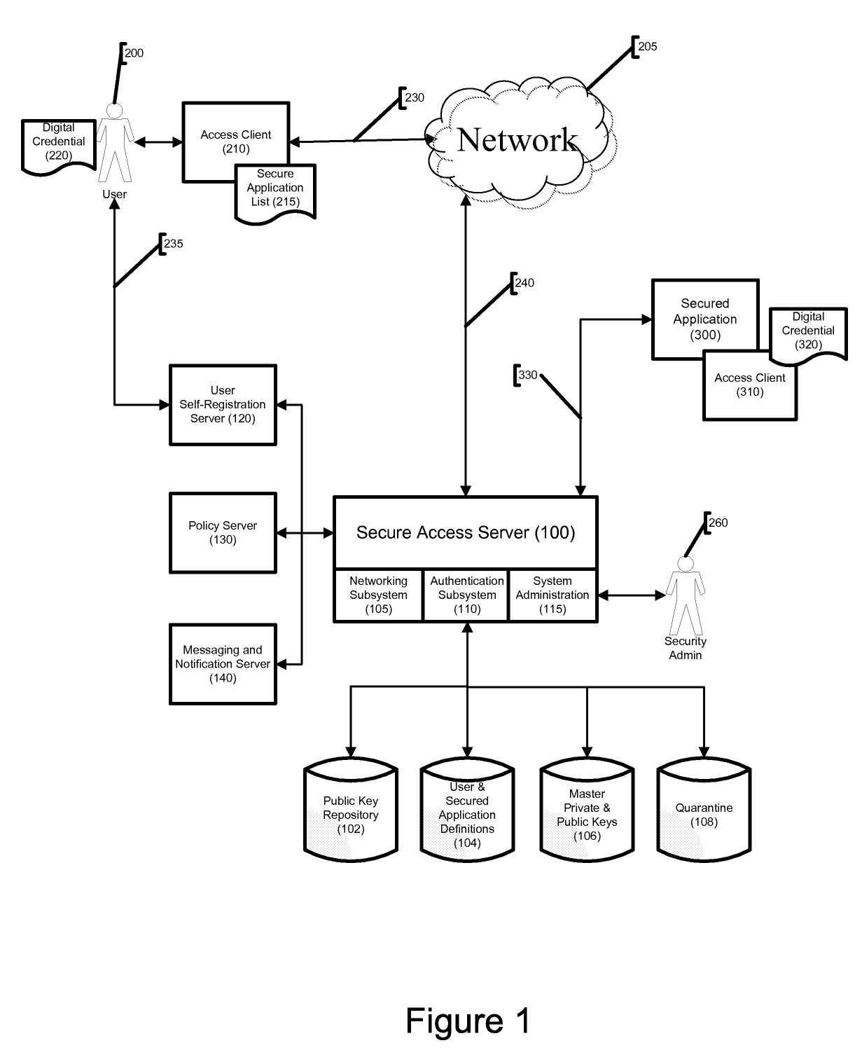

Referring now to FIG. 1, the functional elements of a preferred embodiment of the present invention are depicted. A legitimate user 200 is first identified within the computer network. This may be accomplished in a variety of ways, but is preferably established by a security administrator 260, someone who has access to the administration of the network. A user 200 may be identified by the applications user 200 is allowed access to, and any policies or restrictions that may apply to user 200. This information is preferably stored in a location accessible to Secure Access Server 100, such as on a Policy Server 130. Policy Server 130 may be physically located as part of Secure Access Server 100, but in FIG. 1 is illustrated as a separate server.

Prior to operating the system and method of the present invention, a Secure Access Client 210 must be installed onto a user's 200 computing device, and a Digital Credential 220 created. Digital Credential 220 may be used to authenticate legitimate users and preferably comprises a set of at least two encryption keys used to digitally sign, encrypt, decrypt and authenticate digital signatures for secured communications. Digital Credential 220 is preferably stored on a portable digital medium and remains in the physical possession of its owner. In the preferred embodiment, Digital Credential 220 is encrypted with a pass phrase known only to its owner, so that even if an unauthorized user gains access to Digital Credential 220 and access client 210, the unauthorized user still cannot communicate with Secure Access Server 100 without the confidential pass phrase. As further described below, communications that are encrypted and digitally signed with a legitimate user's Digital Credential 220 are tested by the Secure Access Server 100 in order to establish their authenticity and thus the identity of the sending user.

In the preferred embodiment of the invention, a Self-Registration Server 120 is established that has a means for authenticating users. This means may comprise a set of challenge questions that only user 200 would know the answer to, like the user's birthplace, mother's maiden name, pet's name, or any variety of personal questions that are easily remembered by a user. If self-registration server 120 is utilized with challenge questions, then user 200 does not have to remember a particular password in order to operate the system of the present invention. The generation of Digital Credential 220 may occur by user 200 first receiving an email invitation containing a link to establish communication 235 with self-registration server 120. Accessing self-registration server 120 allows a legitimate user 200 to authenticate himself in order to generate Digital Credential 220. Proper authentication results in the generation of cryptographic keys that are part of Digital Credential 220. If the preferred asymmetric cryptography discussed more fully herein is utilized, then two mathematically related keys, the user's private key and public key are generated. The user's public key is stored in a location accessible to Secure Access Server 100, depicted in FIG. 1 as Public Key Repository 102. In addition to the user cryptographic keys, Secure Access Server 100 may utilize its own pair of public and private cryptographic keys to perform asymmetric cryptography on communications sent from that server. Such keys are referenced herein as a master public key and master private key. The master public and private keys may be generated during installation of Secure Access Server 100, and may be stored in a location accessible to Secure Access Server 100, depicted in FIG. 1 as Master Public & Private Keys 106. In this embodiment, the user's private key and the previously generated master public key together comprise the legitimate user's Digital Credential 220. Digital Credential 220 may be preferably stored on a portable computer storage medium in the physical possession of user 200, and is preferably protected by a pass phrase known only to the user. In this way, a would-be unauthorized user of the network system would not only have to gain access to a Secure Access Client 210, but also a valid Digital Credential 220 in order to communicate with Secure Access Server 100. If Digital Credential 220 is further protected by a user's personally selected pass phrase, then yet another level of security is added.

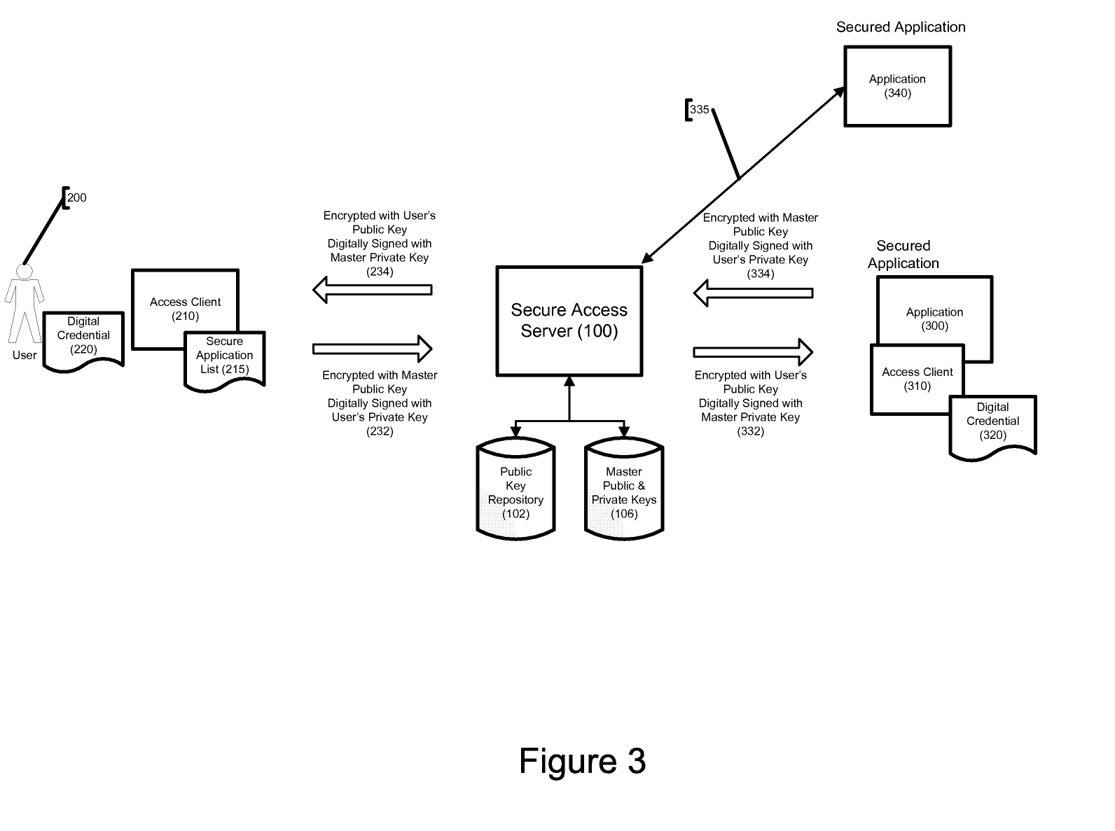

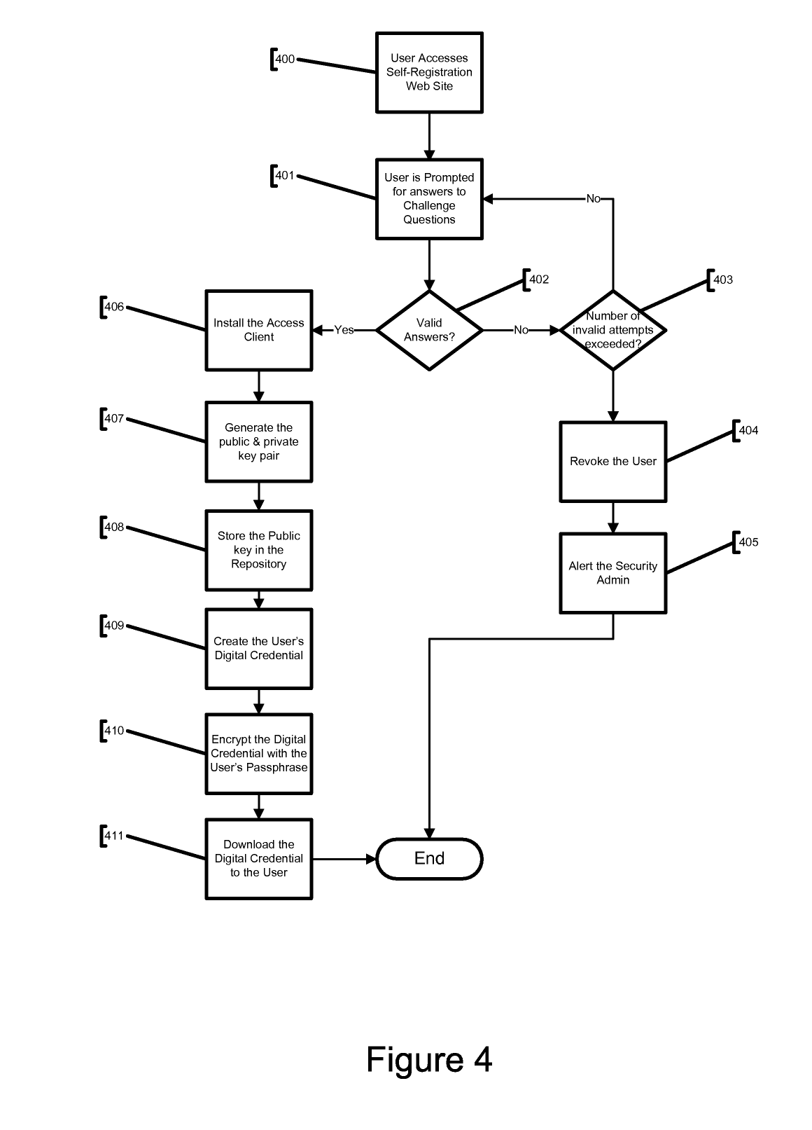

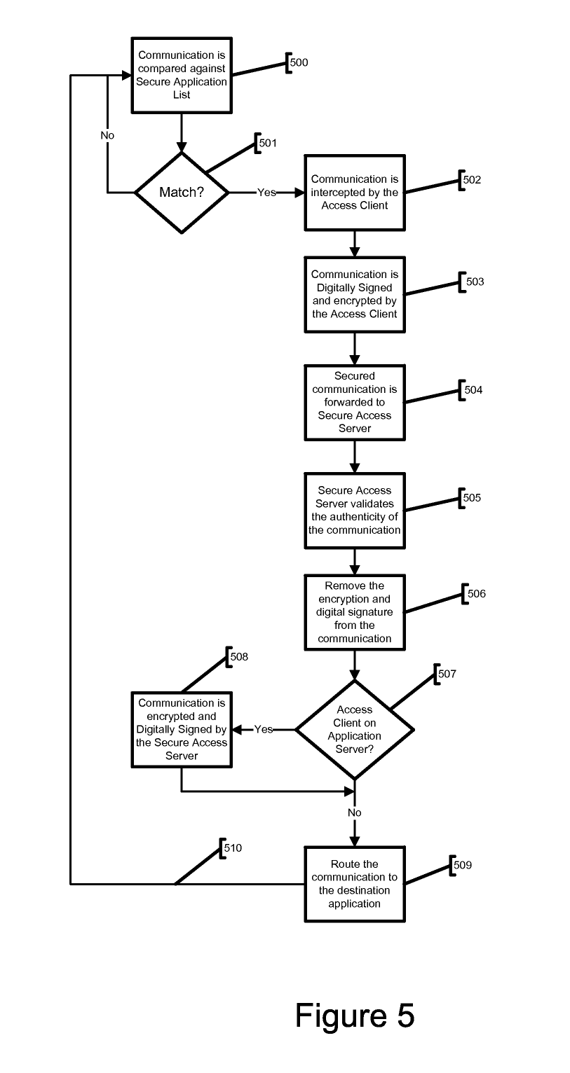

The preferred User Self-Registration process is explained in further detail in FIG. 4 and related discussion herein. The encryption processes to and from Secure Access Clients, Secure Access Server and Secure Applications relative to the keys that are used are more fully detailed in FIG. 3 and FIG. 5, and related discussions herein.

Still referring to FIG. 1, a legitimate user 200 is shown, possessing a previously generated Digital Credential 220 and accessing a computing device with Access Client 210 installed. Access Client 210 establishes contact with Secure Access Server 100 via the communication network 205 in order to establish a communication session. The communication network preferably utilizes secured communication ports, but may also be a public communication network such as the Internet. A “communication session” is simply a limited period of time during which communication between Access Client 210 and Secure Access Server 100 remains open. If no previous communication session exists between Access Client 210 and Secure Access Server 100, then Access Client 210 preferably first authenticates user 200. Authentication may preferably consist of two steps; the first requires user 200 to provide Access Client 210 the path/location and pass phrase (if used) for Digital Credential 220. The second step is Access Client 220 sending a communication to Secure Access Server 100 to initiate the communication session. Communication sessions may be initiated and maintained using the Networking Subsystem 105, shown in FIG. 1 as subsystem of Secure Access Server 100.

Once a communication session is established, Access Client 210 may authenticate user 200 to Secure Access Server 100 by digitally signing, encrypting, and transmitting a small amount of data, such as one byte, to Secure Access Server 100 using the encryption keys of Digital Credential 220. Assuming the preferable asymmetric cryptography method is used, Access Client 210 may encrypt the message with the master public key, and digitally sign the message with the user's private key. Secure Access Server 100 may then decrypt the transmission with the master private key 106, and test the authenticity of the digital signature with the user's public key accessed from Public Key Repository 102. Secure Access Server 100 communicates the results of the authenticity test back to Access Client 210. If Digital Credential 220 is found to be authentic, then Access Client 210 may begin intercepting and securing communications intended for secured applications. If the authenticity test failed then the communication session should be terminated. Communications that fail authentication are preferably quarantined 108 and alerts may be issued to the security administrator 260 utilizing the messaging and notification server 140. The quarantine 108 allows administrator 260 to safely view and analyze failed communications at a subsequent time. Messaging and notification server 140 is depicted in FIG. 1 as a separate server, but in practice could be part of the server acting as Secure Access Server 100.

Assuming the authenticity test is passed, Secure Access Server 100 preferably has access to Policy Server 130 to determine which applications legitimate user 200 is authorized to communicate with. In the preferred embodiment, the definitions contained in Policy Server 130 are created by Policy Server 130 utilizing definitions provided by User and Secured Application Definitions 104. The User and Secured Application definitions may be input by Security Administrator 260. Access Client 210 preferably communicates with Secure Access Server 100 to maintain and periodically update a Secure Application List 215. Secure Application List 215 may comprise definitions from the User and Secured Applications Definitions 104. Access Client 210 may reference Secure Application List 215 for the destination, such as the IP and port address, of communications intended for secured applications. Using that information, Access Client 210 may intercept and secure such communications in keeping with the present invention. Access Client 210 preferably monitors all communications leaving legitimate user's 200 computing device, comparing the associated port and IP addresses of the communications to Secure Application List 215. Communications that match the Secure Application List 215 are intercepted, and may be encrypted and digitally signed. The encryption and digital signing is conducted by the Secure Access Client 210, utilizing the cryptographic keys of Digital Credential 220.

Upon receipt of the encrypted communication, Secure Access Server 100 decrypts and authenticates the communication as described more fully below. Secure Access Server 100 then forwards the communication to the appropriate application located within the computer network. In this way, all communication is first routed through Secure Access Server 100 for authentication and verification before the communication is forwarded to any application. This prevents malicious attacks from within the network itself. As an added layer of security, communication intended for an application may be re-encrypted by Secure Access Server 100 in a manner similar to the encrypted communications between Access Client 210 and Secure Access Server 100. In such case, the server housing secured application 300 may also include an application access client 310 and application digital credential 320, that perform the same basic functions as Access Client 210 and digital credential 220 associated with user 200.

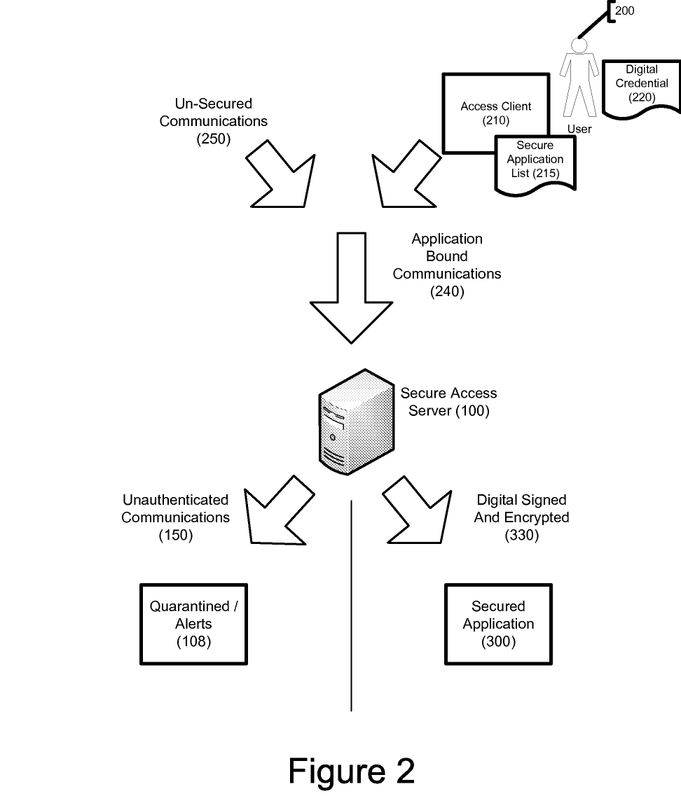

Referring now to FIG. 2, the flow of authorized communications is compared to the treatment of unsecured communications that attempt to connect to a network application. All application bound communications 240 whether they originated from an Access Client 210 and legitimate user 200 or are unsecured 250 will first pass through Secure Access Server 100. Secure Access Server 100 tests all communications destined for secured applications 300 in order to determine the authenticity of communications before allowing them to be transmitted. Communications that fail authentication 150 are quarantined 108 and alerts are issued to the security administrator 260. The quarantine 108 allows an administrator to safely view and analyze failed communications at a subsequent time.

Preferably, all communication transmissions are logged and stored with the Messaging and Notification Server 140. Communications that fail authenticity tests are stored in the quarantined 108 and alerts are posted to the Message and Notification Server 140 where the security administrator 260 is then alerted.

Referring now to FIG. 3, the preferred encryption and decryption process of the present invention is more fully explained. Communications originating from Access Client 210 and transmitted to Secure Access Server 100 are digitally signed with the user's private key and then encrypted with the master public key, both of which comprise Digital Credential 220. The digitally signed and encrypted communication may then be transmitted to Secure Access Server 100. Secure Access Server 100 decrypts the message with the master private key and accesses the user's public key, stored in Public Key Repository 102, to authenticate the sender's digital signature. If the communication is authentic and authorized, the decrypted message may then be passed along to the appropriate secured application 300, 340, which is most likely located on a separate server within the network. One optional aspect of the present invention is the ability to add another layer of security by separately encrypting messages intended for a secured application. To accomplish this, the secured application server 300 may also have an access client 310 and its own digital credential 320 comprising a private key associated with the application, and a master public key. Secure Access Server 100 may re-encrypt the communication using a public key associated with the secured application and the master private key. Application Access Client 310 may decrypt the communication using the master public key and the private key stored on application digital credential 320. Communication from secured application 300, 340 back to user 200 follows the reverse path of encryption and decryption.

Referring now to FIG. 5, a flow chart is provided more fully illuminating the preferred encryption, decryption, and digital signing method of the present invention. The flow chart presumes that user 200 has already been authenticated by Access Client 210 and Secure Access Server 100. Access Client 210 preferably compares all communications from the computing device against secure application list 215, 500, 501, and intercepts those communications intended for a secured application 300, 502. The communication is then digitally signed and encrypted by Access Client 210 using Digital Credential 220, 503. In the preferred embodiment, a random number generator that may be part of Secure Access Client 210 generates a random number of bytes, which constitutes a shared secret for symmetric encryption. The communication is then processed with a message digest algorithm to generate a message digest, which will be used upon reception to test whether the communication has been altered in route to Secure Access Server 100. The message digest is then digitally signed using the user's private key from Digital Credential 220. The communication and the signed message digest are symmetrically encrypted using the shared secret that was randomly generated. The shared secret is then asymmetrically encrypted using the master public key from Digital Credential 220. In this way, the communication is protected with the simplicity of symmetric cryptography, but the shared secret cannot be easily misappropriated because it is protected with asymmetric cryptography. One must have access to the corresponding master private key of the intended receiver in order to decrypt the shared secret. In addition, the digital signature sent with the message digest is asymmetrically encrypted with the private key of the sender. Secure Access Server 100 is preferably designed to only accept messages with authentic digital signatures, and such signatures cannot be copied or compromised by unauthorized users without a legitimate user's private key, thus Secure Access Server 100 should reject attempted communications from all other sources, including all unauthorized users.

Secure Access Server 100 receives all secure communications from Secure Access Client 210 for decryption and authentication 504. Secure Access Server 100 decrypts the shared secret using the master private key 106, and then uses the shared secret to decrypt the communication. Secure Access Server 100 will then regenerate the message digest. The message digest received from Access Client 210 is then compared to the regenerated message digest to determine if they are equal, and thus whether the communication has been altered in route 505. Secure Access Server 100 then decrypts the digital signature with the user's public key for verification 505.

If the digital signature is authentic, the encryption and digital signature are removed 506, and the communication is forwarded to the appropriate secured application 300. Secure Access Server 100 determines the destination application of the communication and whether an application access client 310 is present on the application server 507. If an Access Client is present on the application server destination, the communication is digitally signed and re-encrypted 508 and forwarded to the secure application 509. If an Access Client is not present at the application server, the communication is transmitted as decrypted, with no security from Secure Access Server 100 to the destination secure application 509. Once transmission is complete, the process is repeated 510 until the legitimate user logs off Access Client 210 or Secure Access Server 100 terminates its communication session.

Communications originating from the secured application 300 which are returning back to Access Client 210 and authenticated legitimate user 200 follow the same communication path back to the legitimate user in which they arrived. Secure Access Server 100 preferably encrypts the message from the secured application in a similar manner that communications from Access Client 210 are encrypted. In the preferred embodiment, the server accesses a random number generator to create a random number of bytes resulting in a shared secret. A message digest is generated which will be used on communication reception to determine whether the message was altered. The message digest is digitally signed with the master private key. The communication and the digitally signed message digest are then symmetrically encrypted using the randomly generated shared secret. The shared secret is then asymmetrically encrypted with the receiving user's public key. Upon receipt by access client 210, the client has access to the user's private key to decrypt the shared secret, decrypts the communication with the shared secret, and then tests the authenticity of the digital signature in a similar manner as previously described for receipt of communication by secure access server 100.

Referring to FIG. 4, the diagram depicts a flowchart showing a possible registration process that a user 200 could be required to complete to authenticate and generate their Digital Credential 220. The legitimate user accesses the User Self-Registration Web site 400 by clicking on the link in an email invitation they received. The user is prompted to provide the answers to the Challenge Questions 401. The user has a pre-specified number of attempts to correctly answer the Challenge questions (402, 403). The pre-specified number of attempts is decided and maintained by the security administrator 260. If the user exceeds the number they are revoked 404 and the security administrator is alerted 405. The revoke status prevents the user from attempting Self-Registration until it has been reset by the security administrator.

If the Challenge Questions are correctly answered, the user is prompted to download and install the Access Client 210, 406. When Access Client 210 has been properly installed, the user's public and private key pair 407 is generated. The public key is stored in the Public Key Repository 408. The master public key is included with the user's generated private key to comprise their Digital Credential 220, 409. The user is prompted for a pass phrase in order to symmetrically encrypt the Digital Credential 220, 410. The Digital Credential 220 is downloaded and stored on portable media to remain in the possession of the user 200, 411.

The present invention provides simplicity and a framework where businesses can focus on specific critical applications and their legitimate users. This provides the ability for businesses to change their focus away from the arduous task of identification of illegitimate communications towards the identification of legitimate ones. This enables simplistic method of separating and stopping illegitimate or malicious communications which dramatically improves overall security. All illegitimate communications should be stopped by Secure Access Server 100, and should never proceed further inside the computer network.

Other features and advantages of this invention will be readily apparent to those skilled in the art. While this invention has been described fully and completely with special emphasis upon a preferred embodiment, it should be understood that within the scope of the appended claims the invention may be practiced otherwise than as specifically described herein. It should be understood to those skilled in the art that other modifications and changes can be made without departing from the spirit and scope of the invention and without diminishing its attendant advantages. It is therefore intended that such changes and modifications be covered by the following claims.

What is claimed is:

1. A computer network system for securing user communication with a software application comprising:
a) a digital credential comprising at least one user cryptographic key that is unique to an authorized user of a software application;
b) an access client installed on a computing device, said client having access to the cryptographic key stored on said digital credential and capable of using said cryptographic key to encrypt at least a portion of a communication intended for the application and capable of decrypting an encrypted portion of a received communication intended for the user;
c) a secure access server in digital communication with the access client, said server having access to stored cryptographic keys and capable of using the stored keys to decrypt communication from the client and encrypt communication to the client; and
d) an application server comprising the software application, said application server in digital communication with said secure server;
wherein, all communication between the user and the software application passes from the access client to the secure access server and then to the application server, and wherein the communication between the access client and the secure server is encrypted.

2. The computer network system of claim 1 further comprising a secured application list accessible to the access client, said secured application list comprising the addresses for communications intended for the network system, wherein the access client monitors communications intended for transmission by the computing device and intercepts only those communications intended for the network system for decryption.

3. The computer network system of claim 1 wherein said digital credential is stored on a portable digital medium.

4. The computer network system of claim 1 wherein said digital credential is encrypted with a pass phrase known to the user so that the user must provide the pass phrase to the access client for said access client to access said cryptographic key.

5. The computer network system of claim 1 wherein said digital credential comprises at least two keys used for asymmetric cryptography, a user private key and a master public key, and wherein the stored cryptographic keys accessible to the secure access server include two corresponding asymmetric cryptographic keys, a user public key and a master private key.

6. The computer network system of claim 1 wherein:
(i) said digital credential comprises at least two keys used for asymmetric cryptography, a user private key and a master public key, and wherein the stored cryptographic keys accessible to the secure access server include two corresponding asymmetric cryptographic keys, a user public key and a master private key; and
(ii) said digital credential is stored on a portable digital medium and is encrypted with a pass phrase known to the user so that the user must provide the pass phrase to said access client in order for said access client to access said cryptographic keys.

7. The computer network system of claim 5 wherein the access client comprises a means for generating a shared secret for symmetric cryptography and a message digest algorithm, and wherein the encryption and decryption of communication from the access client to the secure access server comprises the following steps:
(i) a shared secret for symmetric cryptography is generated;
(ii) the communication is processed with the message digest algorithm to generate a message digest;
(iii) the message digest is digitally signed with the user's private key;
(iv) the communication and the digitally signed message digest are symmetrically encrypted using the shared secret;
(v) the shared secret is asymmetrically encrypted using the master public key;
(vi) the access client sends the encrypted communication and message digest to the secure access server;
(vii) the secure access server uses the master private key to decrypt the shared secret;
(viii) the decrypted shared secret is used to decrypt the communication and message digest; and
(ix) the user's public key is used to authenticate the digital signature.

8. The computer network system of claim 7 wherein the means for generating a shared secret comprises a random number generator and the shared secret is created from a random number of bytes generated by the random number generator.

9. A computer network system for securing user communication with a software application comprising:
a) a user digital credential comprising at least one user cryptographic key that is unique to an authorized user of a software application;
b) a user access client installed on a computing device, said user access client having access to the cryptographic key stored on said user digital credential and capable of using said cryptographic key to encrypt at least a portion of a communication intended for the application and capable of decrypting an encrypted portion of a received communication intended for the user;
c) a secure access server in digital communication with the user access client, said server having access to stored cryptographic keys and capable of using the stored keys to decrypt the encrypted portion of a communication from the user access client and encrypt at least a portion of a communication to the client, and capable of encrypting of using the stored keys to encrypt at least a portion of a communication intended for the application and to decrypt the an encrypted portion of a communication from the application; and
d) an application server in digital communication with the secure access server, said application server comprising the software application, an application digital credential including at least one cryptographic key, and an application access client having access to the cryptographic key stored on the application digital credential and capable of using said cryptographic key to decrypt the encrypted portion of a communication from the secure access server and to encrypt at least a portion of a communication to the secure access server;
wherein, all communication between the user and the software application passes through the secure access server, and wherein the communication between the user access client and the secure access server is encrypted, and communication between the secure access sever and the application access client is encrypted.

10. The computer network system of claim 9 further comprising a secured application list accessible to the access client, said secured application list comprising the addresses for communications intended for the network system, wherein the access client monitors communications intended for transmission by the computing device and intercepts only those communications intended for the network system for decryption.

11. The computer network system of claim 9 wherein said user digital credential is stored on a portable digital medium.

12. The computer network system of claim 11 wherein said user digital credential is encrypted with a pass phrase known to the user so that the user must provide the pass phrase to the access client for said access client to access said cryptographic key.

13. The computer network system of claim 9 wherein said application digital credential comprises at least two keys used for asymmetric cryptography, a user private key and a master public key, and wherein the stored cryptographic keys accessible to the secure access server include two corresponding asymmetric cryptographic keys, a user public key and a master private key.

14. The computer network system of claim 13 wherein the user access client comprises a means for creating a shared secret for symmetric cryptography and a message digest algorithm, and wherein the encryption and decryption of communication from the user access client to the secure access server comprises the following steps:
(i) a shared secret for symmetric cryptography is created;
(ii) the communication is processed with the message digest algorithm to generate a message digest;
(iii) the message digest is digitally signed with the user's private key;
(iv) the communication and the digitally signed message digest are symmetrically encrypted using the shared secret;
(v) the shared secret is asymmetrically encrypted using the master public key;
(vi) the access client sends the encrypted communication and message digest to the secure access server;
(vii) the secure access server uses the master private key to decrypt the shared secret;
(viii) the decrypted shared secret is used to decrypt the communication and message digest; and
(ix) the user's public key is used to authenticate the digital signature.

15. The computer network system of claim 14 wherein the means for creating a shared secret comprises a random number generator and the shared secret is created from a random number of bytes generated by the random number generator.

16. The computer network system of claim 9 further comprising a second application server having a second secured application wherein communication between the secure access server and the second application server is not encrypted.

17. A method for securing user communication with a software application comprising:
a) providing a digital credential comprising at least one user cryptographic key that is unique to an authorized user of the software application;
b) a first encryption step in which an access client installed on a computing device and having access to the cryptographic key stored on said digital credential uses the cryptographic key to encrypt at least a portion of a communication input by the user and intended for a software application;
c) a first sending step in which the encrypted user communication is sent to a secure access server;
d) a first decryption step in which the secure access server utilizes at least one stored cryptographic key to decrypt the encrypted portion of the user communication;
e) a second sending step in which the decrypted user communication is sent to an application server comprising the software application;
f) a response step in which the application prepares a new communication responsive to the communication it received from the user;
g) a third sending step in which the application communication in response to the user communication is sent by the application server to the secure server;
h) a second encryption step in which the secure server utilizes at least one stored cryptographic key to encrypt at least a portion of the application communication;
i) a fourth sending step in which the encrypted application communication is sent to the access client; and
j) a second decryption step in which the access client uses the user cryptographic key to decrypt the encrypted portion of the application communication.

18. The method of claim 17 wherein said digital credential is stored on a portable digital medium.

19. The method of claim 18 wherein said digital credential is encrypted with a pass phrase known to the user so that the user must provide the pass phrase to the access client for said access client to access said cryptographic key.

20. The method of claim 17 wherein said digital credential comprises at least two keys used for asymmetric cryptography, a user private key and a master public key, and wherein the stored cryptographic keys accessible to the secure access server include two corresponding asymmetric cryptographic keys, a user public key and a master private key.

21. The method of claim 20 wherein said access client comprises a means for creating a shared secret for symmetric cryptography and a message digest algorithm, and wherein said first encryption step comprises the following steps:
(i) a shared secret for symmetric cryptography is created;
(ii) the communication is processed with the message digest generator to generate a message digest;
(iii) the message digest is digitally signed with the user's private key;
(iv) the communication and the digitally signed message digest are symmetrically encrypted using the shared secret; and
(v) the shared secret is asymmetrically encrypted using the master public key.

22. The method of claim 21 wherein the means for creating a shared secret comprises a random number generator and the shared secret is created from a random number of bytes generated by the random number generator.

23. The method of claim 21 wherein the first decryption step comprises the following steps:
(i) the secure access server uses the master private key to decrypt the shared secret;
(ii) the decrypted shared secret is used to decrypt the communication and message digest; and
(iii) the user's public key is used to authenticate the digital signature.

24. The method of claim 17 further comprising a communication interception step before the first encryption step wherein the access client monitors communications intended for transmission by the computing device and intercepts only those communications intended for the network system for decryption.

25. A method for securing user communication with a software application comprising:
a) providing a digital credential comprising at least one user cryptographic key that is unique to an authorized user of a software application;
b) a first encryption step in which a user access client installed on a computing device and having access to the cryptographic key stored on said digital credential uses the cryptographic key to encrypt at least a portion of a communication input by a user and intended for the software application;
c) a first sending step in which the encrypted user communication is sent to a secure access server;
d) a first decryption step in which the secure access server utilizes at least one stored cryptographic key to decrypt the encrypted portion of the user communication;
e) a second encryption step in which the secure server utilizes at least one stored cryptographic key to re-encrypt at least a portion of the user communication;
f) a second sending step in which the re-encrypted user communication is sent to an application server comprising the software application;
g) a second decryption step in which an application client installed on the application server uses at least one stored cryptographic key to decrypts the re-encrypted user communication;
h) a response step in which the application prepares a new communication intended for the user;
i) a third encryption step in which the application access client uses a stored cryptographic key to encrypt at least a portion of the application communication;
j) a third sending step in which the encrypted application communication is sent from the application access client to the secure access server;
k) a third decryption step in which the secure access server utilizes at least one stored cryptographic key to decrypt the encrypted portion of the application communication;
l) a fourth encryption step in which the secure server utilizes at least one stored cryptographic key to re-encrypt at least a portion of the application communication;
m) a fourth sending step in which the encrypted application communication is sent to the user access client; and
n) a fourth decryption step in which the user access client uses the user cryptographic key to decrypt the encrypted portion of the application communication.

26. The method of claim 25 wherein said digital credential is stored on a portable digital medium.

27. The method of claim 26 wherein said digital credential is encrypted with a pass phrase known to the user so that the user must provide the pass phrase to the user access client in order for said user access client to access said cryptographic key.

28. The method of claim 26 wherein said digital credential comprises at least two keys used for asymmetric cryptography, a user private key and a master public key, and wherein the stored cryptographic keys accessible to the secure access server include two corresponding asymmetric cryptographic keys, a user public key and a master private key.

29. The method of claim 28 wherein said access client comprises a means for creating a shared secret for symmetric cyrptography and a message digest algorithm, and wherein said first encryption step comprises the following steps:
(i) a shared secret for symmetric cryptography is created;
(ii) the communication is processed with the message digest generator to generate a message digest;
(iii) the message digest is digitally signed with the user's private key;
(iv) the communication and the digitally signed message digest are symmetrically encrypted using the shared secret; and
(v) the shared secret is asymmetrically encrypted using the master public key.

30. The method of claim 29 wherein the first decryption step comprises the following steps:
(i) the secure access server uses the master private key to decrypt the shared secret;
(ii) the decrypted shared secret is used to decrypt the communication and message digest; and
(iii) the user's public key is used to authenticate the digital signature.

31. The method of claim 30 further comprising a communication interception step before the first encryption step wherein the access client monitors communications intended for transmission by the computing device and intercepts only those communications intended for the network system for decryption.

32. A method of authenticating and securing user communication with a computer network comprising:
(a) providing a user digital credential comprising at least two cryptographic keys, at least one of which is unique to the user;
(b) providing an access client installed on a computing device in digital communication with the computer network, said access client capable of using cryptographic keys to encrypt and digitally sign a communication intended for the computer network such that said communication may be decrypted and authenticated by the computer network;
(c) providing the access client with the location of the digital credential so that the access client may access the cryptographic keys of the digital credential to encrypt and digitally sign a communication intended for the computer network.

33. The method of claim 32 wherein said digital credential is stored on a portable digital medium.

34. The method of claim 33 wherein said digital credential is encrypted with a pass phrase known to the user so that the user must enter the pass phrase into the computing device in order for said access client to access said cryptographic keys.

35. The method of claim 32 wherein said digital credential is created by the following steps:
(i) using a computing device, a user initiates communication with a network server programmed to verify the user;
(ii) the network server verifies the identity of the user; and
(iii) the network server generates cryptographic keys and creates the digital credential.

36. The method of claim 35 wherein the network server has access to previously saved challenge questions and answers and verifies the user by presenting the user with a set challenge questions and requiring the user to provide correct answers to said questions, such that the user is verified if the user's answers match the saved answers.
